(19) United States
(12) Patent Application Publication
(10) Pub. No.: US 2012/0130769 A1
(43) Pub. Date: May 24, 2012

(54) METHODS FOR CONDUCTING MARKET RESEARCH UTILIZING A TELEMATICS SERVICE SYSTEM

(75) Inventors: ANIL KUMAR MADDULAPALLI, BANGALORE (IN); N.R. SRINIVASA RAGHAVAN, BANGALORE (IN)

(73) Assignee: GM GLOBAL TECHNOLOGY OPERATIONS, INC., DETROIT, MI (US)

(21) Appl. No.: 12/950,537

(22) Filed: Nov. 19, 2010

(51) Int. Cl. G06Q 10/00; G06Q 30/00

(52) U.S. Cl. 705/7.32; 705/7.29

(57) ABSTRACT

A method for conducting market research utilizing a telematics service system that provides a telematics service to a plurality of vehicles is disclosed herein. The method includes, but is not limited to, wirelessly communicating with a plurality of vehicles using the telematics service system. The method also includes obtaining information from the plurality of vehicles using the communications system. The information relates to a usage of each vehicle of the plurality of vehicles. The method further includes utilizing the information to determine an appropriate design for a future vehicle.

### TECHNICAL FIELD

The technical field generally relates to market research, and more particularly relates to methods for conducting market research utilizing a telematics service system.

### BACKGROUND

When designing a vehicle for introduction into the marketplace, it is desirable to ascertain the wants, likes, dislikes, and experiences of consumers with respect to their vehicles. It is also useful to ascertain the common or typical vehicle usages engaged in by the consumer. Conventional methods of ascertaining this information include, but are not limited to (1) contacting the consumer at their homes or places of business to interview the consumer, (2) providing the consumer with surveys and questionnaires soliciting the desired information, and (3) hosting clinics where consumers are invited to attend and view images of proposed future products, at the conclusion of which, the consumer is asked to provide feedback.

Although these methods are sufficient, there is room for improvement because the current methods of conducting market research can be cumbersome, inconvenient, and expensive. Furthermore, these techniques may yield information from the consumer that is days, weeks, or months old. The passage of time may result in obtaining information from the consumer that is less reliable than it would be if it were provided contemporaneously with the consumer's use of the vehicle.

### SUMMARY

Various embodiments of methods for conducting market research utilizing a telematics service system are disclosed herein.

In an embodiment, the method includes, but is not limited to, wirelessly communicating with a plurality of vehicles using the telematics service system. The method further includes obtaining information from the plurality of vehicles using the communications system. The information relates to an operator's experience with each vehicle of the plurality of vehicles. The method still further includes utilizing the information to determine an appropriate design for a future vehicle.

In another embodiment, the method includes, but is not limited to, wirelessly communicating with a plurality of vehicles using the telematics service system. The method further includes obtaining information from the plurality of vehicles using the telematics service system. The information relates to a usage by an operator of each vehicle of a monitored vehicle feature mounted to each vehicle of the plurality of vehicles. The method still further includes utilizing the information to determine an appropriate design for a future vehicle.

In yet another embodiment, the method includes, but is not limited to, wirelessly communicating with a plurality of vehicles using the telematics service system. The method further includes obtaining information from the plurality of vehicles using the telematics service system. The information relates to a location traveled to by each vehicle of the plurality of vehicles. The method still further includes utilizing the information to determine an appropriate design for a future vehicle.

### DESCRIPTION OF THE DRAWINGS

One or more embodiments will hereinafter be described in conjunction with the following drawing figures, wherein like numerals denote like elements, and

FIG. 1 is a schematic view illustrating an embodiment of a telematics service system suitable for use with the methods disclosed herein;

FIG. 2 is a flow diagram illustrating an embodiment of a method for conducting market research utilizing a telematics service system;

FIG. 3 is a flow diagram illustrating another embodiment of a method for conducting market research utilizing a telematics service system; and

FIG. 4 is a flow diagram illustrating yet another embodiment of a method for conducting market research utilizing a telematics service system.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

Improved methods for conducting market research are disclosed herein. These methods entail the use of a telematics service system to communicate with an operator of a vehicle for the purposes of collecting information relating to their experience in/with the vehicle. As used herein, the term “operator” when used in conjunction with the term “vehicle” shall refer to either the driver of the vehicle, an occupant of the vehicle, or both. These methods also entail communicating with the vehicle for the purposes of collecting information relating to the operator's usage of certain vehicle features. This information is collected substantially contemporaneously with, or very shortly after the operator's experience with the vehicle and usage of the vehicle features and is therefore more reliable than similar information collected using traditional methods such as surveys and after-the-fact interviews.

Telematics service systems are well known and have become common in the marketplace. One well-known telematics service system is marketed under the trade name “OnStar”. A telematics service system may include, but is not limited to, a telematics unit that is mounted to a plurality of vehicles, a call center equipped with a variety of computer equipment and manned by a plurality of advisors, and a wireless communication network that communicatively connects the call center to the vehicle. The telematics unit may be connected to the vehicle bus and configured to monitor multiple vehicle systems. The telematics unit may be configured for both voice and data communications. The communicative connection between the call center and the vehicle facilitates both voice and data communications between the vehicle/operator, on the one hand, and the call center on the other.

In some instances, communication with the operator may comprise asking the operator a series of questions relating to the operators experience with the vehicle. In other instances, communication with the operator may comprise transmitting still images or video images to the operator that feature potential new products for the purposes of obtaining the operator's opinion/reaction to the new products. In some instances, communication with the vehicle may comprise data communications between the telematics unit and the call center wherein the telematics unit transmits data to the call center pertaining to the operator's usage of the vehicle features and/or locations to which the operator has traveled in the vehicle.

All of this information may be useful to the design of future products. For instance, customer feedback pertaining to the handling, performance, and comfort of a particular vehicle may be used by vehicle designers in equipping and/or tuning future vehicles. Similarly, the frequency or infrequency of use by the operator of certain vehicle features can inform vehicle designers about the usefulness and desirability of the vehicle features. Additionally, by studying the destinations to which operators drive their vehicles, designers can draw conclusions about the purposes for which an operator uses the vehicle and can equip and/or configure future vehicles to better accommodate such usages.

A further understanding of the methods for conducting market research utilizing telematics services may be obtained through a review of the illustrations accompanying this application together with a review of the detailed description that follows.

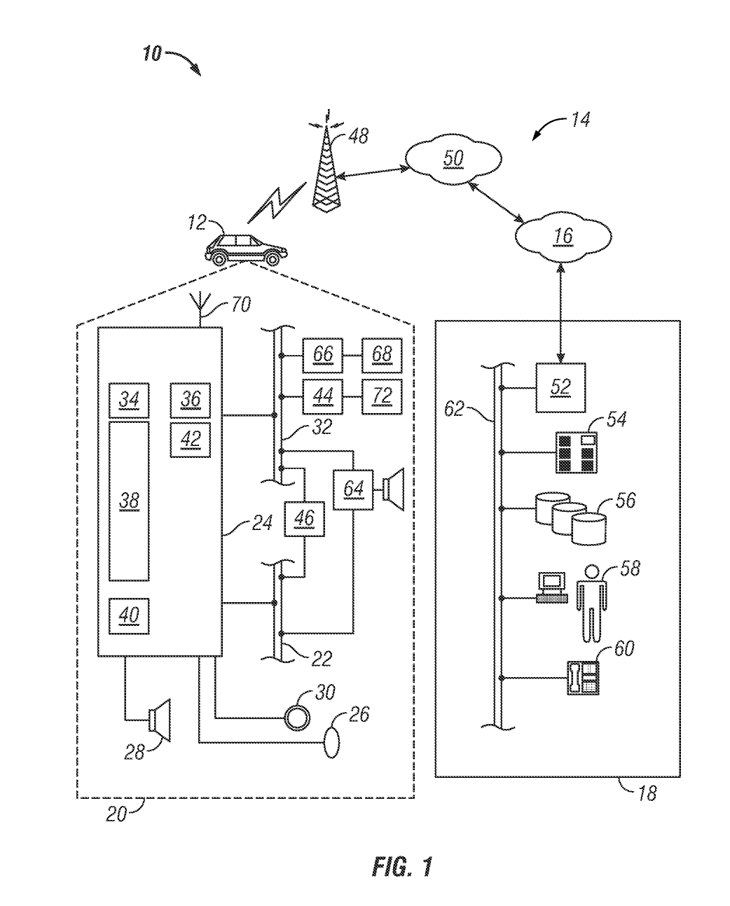

With reference to FIG. 1, there is shown a non-limiting example of a telematics service system 10 that may be used to perform the methods disclosed herein. Telematics service system 10 generally includes a vehicle 12, a wireless carrier system 14, a land network 16 and a call center 18. It should be appreciated that the overall architecture, setup and operation, as well as the individual components of the illustrated system are merely exemplary and that differently configured telematics service systems may also be utilized to implement the examples of the method disclosed herein. Thus, the following paragraphs, which provide a brief overview of the illustrated telematics service system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over telematics service system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the components of vehicle hardware 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

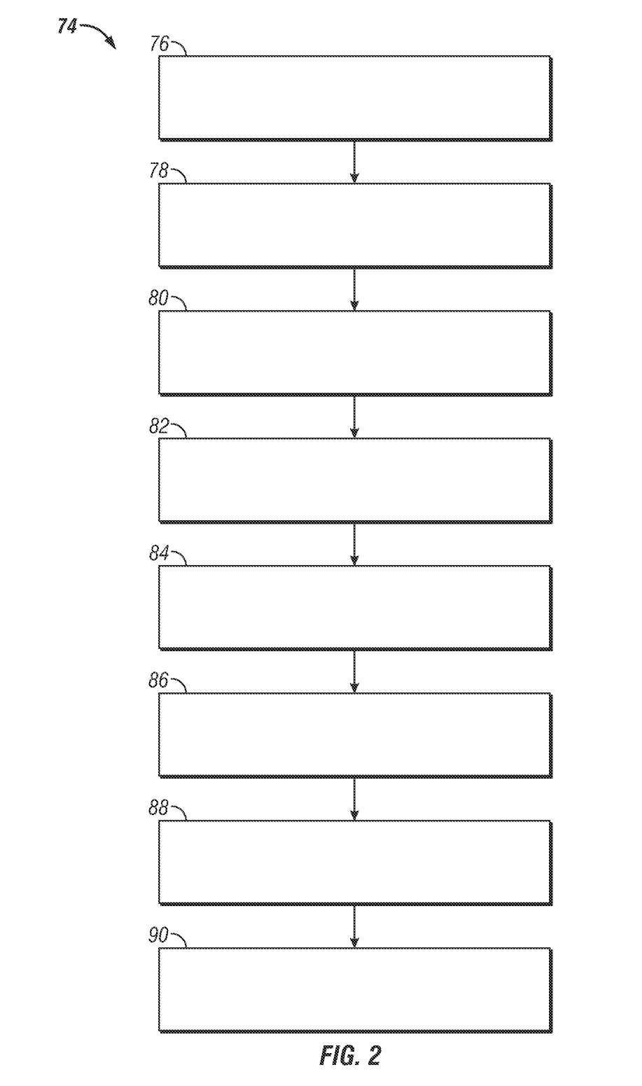

FIG. 2 is a flow diagram illustrating an embodiment of a method 74 for conducting market research utilizing a telematics service system. In the embodiment illustrated in FIG. 2, the market research is carried out through voice communications with the operator. In this embodiment, the operators are asked a series of questions by a market researcher, a call center advisor, or some other person who is remotely located at call center 18, at an analogous facility, or at some other location. The subject matter for such discussions may include, but are not limited to, the operator's experience in and/or with their vehicle and the operator's preference for certain vehicle features. Such conversations may occur contemporaneously with, or immediately after, the operator's experience and is therefore fresh in the operator's mind. With continuing reference to FIGS. 1-2, method 74 may be implemented via telematics service system 10 while in other embodiments, method 74 may be implemented via any other suitable telematics service system.

At block 76, consent is received from each operator of each vehicle of a plurality of vehicles from whom information is sought. Such consent may be obtained at the time that the operator purchases the vehicle, at the time that the operator signs up for telematics service, or at the time that the market research is initiated. In some embodiments, the operator's consent may be obtained at the time of the interview.

At block 78, an interview with each of the operators is scheduled. In some embodiments, a time and date is selected for the interview when each operator anticipates being in the vehicle. In other embodiments, the operators may provide the market researchers with their regular schedule of vehicle operations and may authorize the market researchers to contact the operators during such times. In still other embodiments, the operators may contact the market researchers using telematics service system 10 at a time of the operator's choosing. The market researchers may be on duty at a call center twenty four hours a day to accommodate the varying schedules of the operators. In still other embodiments, no attempts are made to coordinate or schedule an interview. Rather, interview may occur at random times and dates. For example, an interview may be requested and/or given any time that the operator utilizes the telematics service system by contacting a service advisor in the call center. In other examples, the telematics service system may be configured to detect when the operator's vehicle is in motion and may initiate voice communications with the operator at that time.

At block 80, voice communication is initiated with each of the operators using the telematics service system. Voice communication may be initiated by either the operator or the market researcher. In instances where the interview has been scheduled, the market researcher may initiate voice communication with the operator at the date and time agreed to by the operator.

At block 82, voice communication between the operators and market researchers is established. The market researchers and the operators communicate with one another wirelessly using the telematics service system. This voice communication occurs while each operator is located in the vehicle. For example, this voice communication may occur while each operator is driving the vehicle, after the operator is done driving the vehicle but prior to egress from the vehicle, prior to driving the vehicle, or during a break or intermittent discontinuation of vehicle operations.

At block 84, the market researchers obtain information from the operators. The information obtained may relate to each operator's experience operating their respective vehicle. For example, the operator may be asked about mechanical problems which the operator is currently observing or has previously observed with the vehicle. The operator may be asked about mechanical problems that have been experienced by other operators who have the same type, make and/or model of vehicle. The operator may be asked to provide their likes and dislikes regarding their vehicle. The operator may be asked to provide feedback regarding the vehicle's performance and handling. The operator may be asked about the operator's usage of various vehicle features and/or options. The operator may be asked to identify features that are not present in the operator's vehicle that the operator would like to have. The operator may be asked to identify the operator's current destination, the operator's frequent destinations, and the operator's common usages for the vehicle. The operator may be asked to provide feedback in the form of an unguided narrative regarding the operator's vehicle. The operator may also be asked a series of questions from a questionnaire. The above examples are not an exhaustive list of inquiries. Other inquiries may also be made.

At block 86, market researchers may also engage in voice communication with one or more passengers located in the operator's vehicle at the time of the interview. Each passenger may be asked to provide feedback regarding their experience while riding in the vehicle. The questions posed to the passenger may be similar or identical to the questions posed to the operator.

In some embodiments, at block 88, visual information such as pictures or video images may be downloaded to the operator's vehicle using the telematics services. In some embodiments, the visual information may pertain to new products and the operator's feedback on such new products may be requested. The new products may be new or improved feature offerings or new or improved vehicles or new or improved products of any type. The visual information may be demonstrated to the operator on any display screen in the vehicle that is connected (either wirelessly or via a wired connection) to the vehicle bus or connected (either wirelessly or via a wired connection) to a component that is connected to the vehicle bus. Examples of suitable display screens include, but are not limited to, the vehicle's DVD entertainment system, the vehicle's in-dash navigation system, the vehicle's backup camera display screen, an aftermarket navigation system having a wireless connection to the vehicle, a cell phone, or any other wireless portable device that is capable of wirelessly connecting to the vehicle.

At block 90, the information provided by each of the operators may be utilized by the market researchers to determine an appropriate design for future vehicles. For example, the information provided by the operators may be utilized by market researchers to determine the likelihood of success for future products or components thereof based on the responses provided by the operators. The market researchers may also use the information provided by the operators to make recommendations concerning product content such as which features should and should not be offered and which options should and should not be available in a particular vehicle model. Such recommendations may be utilized by product designers to add or delete content from product offerings, and to include or exclude options in certain vehicle lines. Information provided by each of the operators may also be used by market researchers, product designers, manufacturers, or any other entity in any other way.

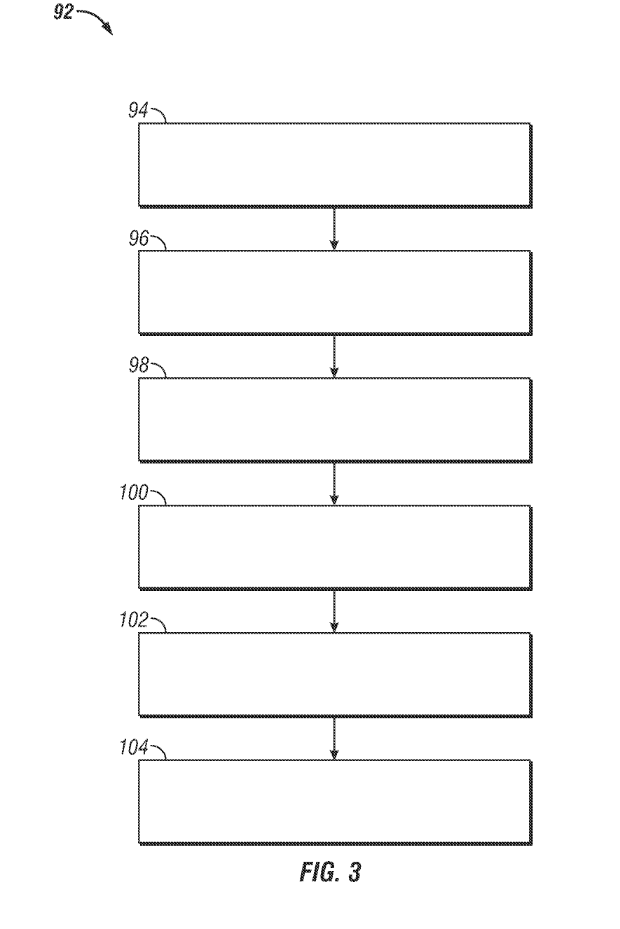

FIG. 3 is a flow diagram illustrating another embodiment of a method 92 for conducting market research utilizing a telematics service system. In the embodiment illustrated in FIG. 3, the market research is conducted via data communications between the telematics unit in the vehicle and the call center. In this embodiment, the operator of each vehicle is not directly involved in the collection of information. Rather, the use or non-use by the operator of a vehicle feature over a predetermined period of time is monitored and reported to the call center. This may be accomplished in many ways.

With continuing reference to FIGS. 1-3, in one embodiment, telematics service system 10 may be used to collect and report this information. Various vehicle features (e.g. heated seats, power windows, DVD entertainment systems, satellite radio systems, dynamic cruise control, etc.) may include sensors that are configured to monitor the state of use of the respective vehicle feature. For example, the sensors may be configured to determine whether the vehicle feature is on or off. These sensors are connected to vehicle bus 32 and may be configured to report the use and/or non-use of their associated vehicle features to telematics unit 24. Telematics unit 24 is configured to store the data provided by the various sensors and to communicate such data to call center 18. Such communication may be initiated either by telematics unit 24 or by call center 18. In this manner, telematics service system 10 (or any other suitable telematics service system) can be used to collect data to support market research in a manner that is minimally intrusive to the operator.

At block 94, the operator of each vehicle consents to the collection and reporting of data regarding the operator's usage of the monitored vehicle features. Such consent may be obtained at the time that the operator purchases the vehicle, at the time that the operator signs up for telematics services, or at the time that the market research is initiated.

At block 96, call center 18 wirelessly communicates with multiple vehicles using telematics service system 10. Such communication may be in the form of an inquiry transmitted by call center 18. In other embodiments, such communication may be in the form of a transmission initiated by telematics unit 24 to each vehicle participating in the market research.

At block 98, call center 18 obtains information from each vehicle participating in market research. The information provided by each vehicle will pertain to the feature or features mounted to the vehicle that is/are the subject of the market research. The information may include a current status for each monitored vehicle system, an historical usage of each monitored vehicle system over a predetermined period time, or both.

At block 100, the information provided by each vehicle participating in the market research is utilized by the market researchers to determine an appropriate design for future vehicle. The data collected by means of method 92 may provide market researchers with a clear picture of how certain vehicle features are and are not being utilized by each operator. This data may be used to guide advertising efforts. For example, at block 102, when the data indicates that a particular vehicle feature is highly utilized (e.g., high percentage of use and/or high frequency of use), marketing efforts for that vehicle feature may be increased to make the buying public aware of the availability of that vehicle feature. The converse is also true. At block 104, if the data indicates that a particular vehicle feature is rarely utilized, designers may take this fact into consideration when designing future models and other vehicles by omitting that vehicle feature from such future models and vehicles.

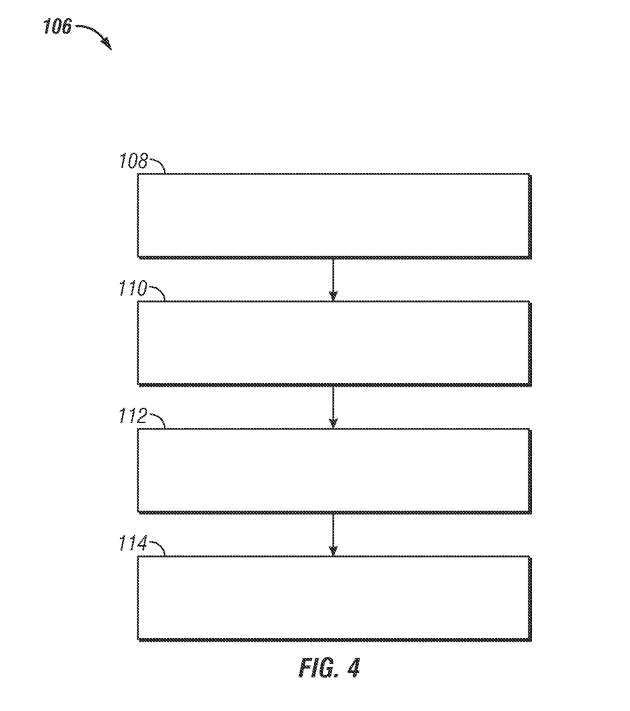

FIG. 4 is a flow diagram illustrating yet another embodiment of a method 106 for conducting market research utilizing a telematics service system. In the embodiment illustrated in FIG. 4, the market research is conducted via data communications between the telematics unit in the vehicle and the call center. In this embodiment, the location and/or destination where the operator drives to the vehicle is recorded and reported to the market researchers. In this embodiment, the operator of each vehicle is not directly involved in the collection of information. Rather, the locations to which the operator drives the vehicle over a predetermined period of time is monitored and reported to the call center. Additionally, the dates, times, and durations of such visits may also be monitored and reported to the call center. This may be accomplished in many ways.

With continuing reference to FIGS. 1-4, in one embodiment, telematics service system 10 may be used to collect and report this information. Telematics unit 24 includes GPS chipset/component 42 which is configured to determine the location of the vehicle. Telematics unit 24 may be configured to monitor the various locations to which the vehicle is driven, to store this information and to periodically communicate this information wirelessly to call center 18. Such wireless communication may be initiated either by telematics unit 24 or by call center 18.

At block 108, wireless communication between the plurality of vehicles participating in the market research and call center 18 is initiated. Such communication may be initiated by the call center for the purposes of soliciting information that has been stored in each vehicle's telematics unit. Alternatively, this communication may be initiated by the telematics unit in each vehicle for the purposes of transmitting such stored information. In still other embodiments, both the call center and the telematics unit may be configured to initiate such communications.

At block 110, the call center obtains information from each vehicle that is participating in the market research. The information identifies the locations where each vehicle has been driven over a predetermined period of time, and the dates, times, and duration of such visits. At block 112, the location information is used to deduce the activities engaged in by the operator. In one embodiment, this may be accomplished by taking the locations included in the information provided by each vehicle (e.g., GPS data) and comparing it with maps that include, but that are not limited to, an identification of known businesses, residences, parks, farms, recreational facilities, landmarks, and/or other type of location classification. For example, if a vehicle is frequently driven to a particular location over a predetermined period of time that is known to be near a shopping center, then it may be deduced that the vehicle is used by the operator to transport the operator to and from the shopping center and to transport cargo and other goods available at the shopping center.

At block 114, the location information provided by each vehicle may be utilized by market researchers to determine the uses for each vehicle and may alter the design for, or offer additional features on future models of that vehicle that make the vehicle better suited to the operator's use. In the example given above, where a vehicle is frequently driven to a shopping center, this information may be used by designers to increase the size of the vehicle's trunk or cargo storage area or to provide additional storage compartments or other features that enhance the vehicle operator's ability to secure cargo in the vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather than, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method for conducting market research utilizing a telematics service system, the method comprising the steps of:
wirelessly communicating with a plurality of vehicles using the telematics service system;
obtaining information from the plurality of vehicles using the telematics service system, the information relating to a an operator's experience with each vehicle of the plurality of vehicles; and
utilizing the information to determine an appropriate design for a future vehicle.

2. The method of claim 1, wherein the wirelessly communicating step comprises initiating voice communication with an operator of each vehicle of the plurality of vehicles while the operator is in the vehicle.

3. The method of claim 2, further comprising the steps of:
procuring consent from the operator to conduct the voice communication prior to initiating the voice communication;
scheduling the voice communication to occur on a predetermined date and at a predetermined time that is acceptable to the operator; and
initiating the voice communication with the operator at the predetermined date and the predetermined time.

4. The method of claim 2, wherein the obtaining step comprises receiving information pertaining to a preference of the operator.

5. The method of claim 2, wherein the obtaining step comprises obtaining a response from the operator to at least one question pertaining to an experience that the operator has had while driving the vehicle.

6. The method of claim 2, wherein the obtaining step comprises obtaining information from the operator that pertains to a maintenance concern that the operator has with respect to the vehicle.

7. The method of claim 2, wherein the obtaining step comprises obtaining from the operator an opinion pertaining to a vehicle feature.

8. The method of claim 2, further comprising the step of engaging in voice communications with a passenger in each vehicle and obtaining information from the passenger relating to an experience of the passenger in the vehicle.

9. The method of claim 2, further comprising the step of downloading new product information to the vehicle and obtaining feedback from the operator pertaining to the new product information.

10. The method of claim 9, wherein the new product information comprises an image of a new product.

11. The method of claim 1, wherein an operator of each vehicle of the plurality of vehicles is offered an incentive to provide the information.

12. A method for conducting market research utilizing a telematics service system, the method comprising the steps of:
wirelessly communicating with a plurality of vehicles using the telematics service system;
obtaining information from the plurality of vehicles using the telematics service system, the information relating to a usage by an operator of each vehicle of a monitored vehicle feature mounted to each vehicle of the plurality of vehicles; and
utilizing the information to determine an appropriate design for a future vehicle.

13. The method of claim 12, wherein the wirelessly communicating step comprises receiving a wireless transmission initiated by each vehicle of the plurality of vehicles.

14. The method of claim 12, wherein the wirelessly communicating step comprises wirelessly transmitting an inquiry to each vehicle of the plurality of vehicles and wirelessly receiving a response to the inquiry from each vehicle of the plurality of vehicles.

15. The method of claim 12 wherein the information relates to the usage by the operator of the monitored vehicle feature over a predetermined period of time.

16. The method of claim 12, further comprising the step of increasing marketing efforts with respect to the monitored vehicle feature if it is determined that the monitored vehicle feature is highly utilized.

17. The method of claim 12, further comprising the step of eliminating the monitored vehicle feature from future vehicles if it is determined that the monitored vehicle feature is rarely utilized.

18. The method of claim 12, further comprising the step of procuring consent from the operator of each vehicle to obtain information prior to the wirelessly communicating step.

19. A method for conducting market research utilizing a telematics service system, the method comprising the steps of:
wirelessly communicating with a plurality of vehicles using the telematics service system;
obtaining information from the plurality of vehicles using the telematics service system, the information relating to a location traveled to by each vehicle of the plurality of vehicles; and
utilizing the information to determine an appropriate design for a future vehicle.

20. The method of claim 19, further comprising the step of deducing an activity engaged in by operator of the vehicle based on the location traveled to by the vehicle.
